(19) United States
(12) Patent Application Publication
(10) Pub. No.: US 2007/0013147 A1
(43) Pub. Date: Jan. 18, 2007

(54) Seal for isostatic press

(76) Inventor: Hakan Granquist, Sala (SE)

Correspondence Address: HARNESS, DICKEY & PIERCE, P.L.C., P.O. BOX 8910, RESTON, VA, 20195, US

(21) Appl. No.: 10/551,722

(22) PCT Filed: Apr. 2, 2004
(86) PCT No.: PCT/SE04/00520

§ 371 Date: Oct. 3, 2005

(30) Foreign Application Priority Data
Apr. 3, 2003 (SE) 0300972-7

(51) Int. Cl. F16J 15/02; F16J 15/00; B65D 53/00

(52) U.S. Cl. 277/632; 220/378; 277/300

(57) ABSTRACT

A seal comprising a sealing arrangement which is applicable in a mounting and intended for a lid of an isostatic press. The sealing arrangement is applicable to allow sealing between the lid and a pressure chamber wall. The sealing arrangement comprises at least two individual circular-arc-shaped segments which together form a closed ring when they are placed in the mounting. Moreover, the seal comprises a stop arrangement which is arranged to limit movements of the segments so that these are kept in the mounting also when the lid is removed from the pressure chamber wall. The invention also relates to a method for sealing a lid and an isostatic press.

### FIELD OF THE INVENTION

The present invention relates to a seal for a removable lid, which is adapted to close a pressure chamber of an isostatic press. The seal is applicable so as to allow sealing between the lid and a pressure chamber wall. The invention also relates to a method for sealing such a lid, and to an isostatic press, a lid, a seal holder and use of a seal for sealing a lid.

### BACKGROUND ART

In hot isostatic presses, a product is inserted into a cylindrical pressure chamber which is then filled with gas under high pressure (for instance 2000 bar) and with a high temperature (for instance 500° C.). The hot gas subjects the product to isostatic, i.e. uniform, high pressure treatment, which means that the product is subjected to the same pressure from all sides. Examples of applications in hot isostatic pressing are sintering of diamond tools, compacting or compressing of metallic or ceramic powder etc.

After the blank or the product which is to be subjected to pressure treatment has been inserted into the pressure chamber, this is closed with a lid. The lid is usually provided with a circumferential main seal and one or more secondary seals in the form of convection limiting sealing rings (one sealing ring may be enough depending on pressure/temperature). The function of the sealing rings is, inter alia, to protect the main seal. Without the sealing rings, the hot gas would leak up to the main seal and destroy this. In addition to the sealing function, they also serve to conduct heat to the adjoining pressure chamber wall.

Each sealing ring is formed as an open ring with two ends. The ends are provided with hooks which can be made to engage each other to close the ring. When the lid is removed from the pressure chamber, the sealing ring is not allowed to come loose and is therefore constructed with limited resilience. The sealing ring is made of cast iron, and although it has limited resilience, the resilience is sufficient to adjust it to the diameter of the cylindrical pressure chamber wall, which is expanded during pressurisation.

A problem with the traditional sealing ring has been discovered in mounting and dismounting, for instance when inspecting for cracks, if any, or removing dirt. The hooks of the sealing ring, which can thus be said to establish a snap lock, easily break in mounting and dismounting since great forces are required to join and/or separate them. Moreover sealing rings of this type are expensive to manufacture.

### SUMMARY OF THE INVENTION

An object of the present invention is to provide a seal which solves the problem in mounting and dismounting of the traditional sealing ring.

Another object of the invention is to establish a seal which is inexpensive and easy to manufacture.

Yet another object of the invention is to provide a press, a lid and a seal holder which can easily be sealed.

A further object of the invention is to provide a simple method for sealing a lid for an isostatic press.

These and other objects that will be evident from the following description are achieved by means of a seal, a method, an isostatic press, a lid, a seal holder and use of a seal as defined in the appended claims.

According to one aspect of the invention, a seal is provided, which comprises a sealing means for a lid of an isostatic press, which sealing means is applicable in a mounting. The lid has a first position, in which it closes a pressure chamber of the isostatic press and a second position in which it is separated from the pressure chamber. The sealing means is applicable in the mounting so that, in said first position, it seals between the lid and a pressure chamber wall. The sealing means comprises at least two individual circular-arc-shaped segments which together form a closed ring when they are placed in the mounting. A stop arrangement is arranged to limit movements of the segments so that these are kept in the mounting also in said second position.

The invention is based on a knowledge that it is possible to provide a good seal by dividing this, instead of using a ring in one piece, so that it consists of at least two individual circular-arc-shaped segments which together form a closed ring when they are placed in the mounting. Due to these individual segments, considerably easier dismounting of the sealing means is achieved than has been possible with the traditional ring joined by hooks. A combination with a stop arrangement makes it possible to keep the segments in the mounting also when the lid has been removed from the pressure chamber and no longer limits the radial movement of the segments.

An advantage, in terms of manufacture, of the use of segments is that that they are cheap to manufacture. The segments can be manufactured, for instance, by milling directly from a sheet metal blank.

The circular-arc-shaped segments together form a closed ring when they are placed in the mounting, i.e. the segments are circumferential and form a whole closed circle without any gap between the segments. This counteracts that hot gas escapes from the pressure chamber, thus establishing a good seal between the lid and the pressure chamber. The segments thus have a sealing function.

The stop arrangement is preferably such that at least one part thereof is removable and separate from the segments, the removal of such a part of the stop arrangement allowing removal of one or more segments from the mounting. It also allows easy mounting and keeping or at least partial locking of the segments by said part being arranged on the segments.

By mounting is here meant some kind of grip or holder, such as a groove. Such a mounting is preferably arranged as a circumferential groove in the cylindrical outer surface of the lid, or in the outer surface of the seal holder belonging to the lid, the outer diameter of which is slightly smaller than the pressure chamber defining inner wall of the isostatic press, in which case the sealing means which is placed in the mounting is adapted to seal against the surrounding wall. However, it is also conceivable, but less preferable, to provide the actual wall with the mounting and, thus, place the sealing means in the wall before the lid is arranged to close the pressure chamber. Even if both alternatives are available, the following description will concentrate on the first alternative, i.e. the mounting is to be found on the lid or a seal holder associated therewith.

Since the sealing means is not made in one piece but consists of several individual segments, these are preferably designed so as to overlap each other when they are placed in the mounting. The overlap counteracts that the gas in the pressure chamber leaks out between juxtaposed segments. The overlap is suitably provided by each segment having, at both ends, a projecting portion which, with the segments placed in the mounting, overlaps a corresponding projecting portion of an adjoining segment. For instance, each element can have one end formed with an upper projecting portion and the other end formed with a lower projecting portion, in which case an upper projecting portion of one segment matches a lower projecting portion of an adjoining segment. However it will be appreciated that the overlap can be provided with other designs of the ends.

As an alternative to the overlap, the segments are designed so as to resiliently abut against each other, end to end, when they are placed in the mounting. This results in a good seal between the segments when they are placed in the mounting, and counteracts that the gas in the pressure chamber leaks out between juxtaposed segments. The resilience is suitably achieved by making one or both end portions of each segment of an elastic material, the ends of one segment, when the segments are placed in the mounting, abutting against the ends of adjoining segments.

In one embodiment of the invention, the segments are individually lockable, i.e. the stop arrangement can be arranged so as to limit the movement of one segment without limiting the movement of the other segments. This can be provided by a stop arrangement which comprises a set of stop elements, which preferably are arrangeable and detachable independently of each other and preferably independently of each other in terms of function, the movement of each segment being limited by at least one stop element, each stop element limiting only the movement of that segment. In its simplest form, each segment thus has one associated stop element. However, it is also conceivable that one or more segments have at least two stop elements each. All these variants allow individual locking or keeping of a segment. In another embodiment of the invention, each stop element could be connected to two or more segments, which, however, affects the possibility of individual mounting and dismounting of the segments.

Each stop element is preferably arrangeable so as to extend between a mounting forming portion and a segment. A mounting forming portion may consist of, for instance, a portion which defines a circumferential groove in the lid or in a seal holder for the lid. If the groove, for instance, has a cross-section in the form of a U or an open rectangle, so that the segment, when arranged in the groove, is surrounded on three sides, any one of the three sides can constitute said mounting forming portion.

In one embodiment of the invention, the stop element is movably arranged relative to the segment, but fixedly arranged relative to the mounting forming portion. This can be provided, for instance, by the stop element being in the form of a screw, bolt, pin or the like which is fixed to the mounting forming portion and which extends into a relatively overdimensioned recess in the segment. By designing the recess so that its extent in the radial direction of extension of the sealing means, i.e. the lid and the pressure chamber, is greater than the corresponding extent of the stop portion of the stop element, which stop portion extends into the recess, some mobility of the segments in the radial direction is allowed. The mobility of the segment is limited radially inwards by said stop portion abutting against the outer end surface, radially seen, of the recess (or alternatively by segments abutting against an inner groove defining wall or some other type of abutment). The mobility is limited radially outwards by said stop portion abutting against the inner end surface, radially seen, of the recess. Thus this arrangement allows the lid to be removed from the pressure chamber without the segment being able to slide out of the mounting. The arrangement allows, however, some radial movement of the segment so that the sealing means, i.e. the ring of segments, can expand radially to adjust to the radial expansion of the pressure chamber wall during pressurisation.

In another embodiment of the invention, the stop element is movably arranged relative to the mounting forming portion, but fixedly arranged relative to the segment. Like the preceding embodiment, this one also allows a relative movement between the segment and the mounting forming portion. In the latter embodiment, the stop element is instead fixed to the segment so that the stop portion of the stop element extends into an over-dimensioned recess or hole in the mounting forming portion. The principle of relative movement and radial limitation, however, corresponds to the above described.

The above-described overdimensioned recesses are preferably only overdimensioned in the radial direction, while they have a relatively close fit to the stop element in the tangential direction. Consequently the stop element effectively counteracts tangential displacement of the segments. This also means that the risk of the segments locking each other is minimised.

To ensure that the seal achieves the intended sealing effect between the lid and the pressure chamber wall, the seal suitably comprises some kind of actuating means which adjusts the radial position of the segments to the change in diameter of the pressure chamber wall. The actuating means can be a purely mechanical arrangement which pushes or pulls the segments. Another alternative is to control the movement of the segments hydraulically or pneumatically, for instance by applying a pressurised fluid in a space between the segments and a mounting forming portion so that the fluid exerts a pressure on the segment radially towards the pressure chamber wall. A further alternative involves actuating the segments by electric circuits or magnetic devices (such as with repellent permanent magnets).

In an advantageous embodiment, use is made of mechanical actuation of the segments in the form of a spring assembly. The spring force strives to move the segments in the radial direction of extension of the sealing means, i.e. the segment ring, so that the segment ring, which is formed by the actuating segments, increases in diameter. The spring force can be provided, for example, by an elastic ring or a plurality of discrete resilient elements, such as rubber pads.

In one embodiment of the invention, the spring assembly comprises a set of individual springs, each segment being actuated by at least one spring, each spring actuating one segment only. In contrast to the traditional sealing ring in one piece, provided with hooks, which has inherent resilience, this function has, according to the described embodiment of the present invention, been transferred to an external spring. It will be appreciated that an advantage of this external spring actuation is that a defect spring assembly, such as an individual defect spring, can easily be replaced by another, without necessitating exchange of the entire seal. The more springs that are used per segment, the less force required from each spring. The use of a plurality of springs has the advantage that it will be easier to exert a uniform pressure on the segments and, thus, on the pressure chamber wall, thereby achieving a uniform sealing effect.

The springs are suitably of the coil spring type. The springs are preferably made of a material with good heat resistance and good resistance to corrosion and oxidation. Examples of materials are metals or alloys, such as nickel alloys, for instance of the type Nimonic 90.

Although it is advantageous in view of mounting that each spring only actuates one dedicated segment, a spring can, according to an alternative embodiment, be arranged to actuate several segments. However, this may have an effect on the desired freedom of movement of the segments. If a spring actuates only one segment and there is nothing else connecting the segments to each other, the segments can freely adjust to the pressure chamber wall. If it appears that the pressure chamber wall expands more in one portion along its circumference than in another portion, one or more segments are thus moved more than the other segments. Also, if irregularities or wear arise in some portions of the pressure chamber wall, the segments, which are movable independently of each other, are adjusted accordingly.

Each spring is preferably adapted to extend from a mounting forming portion to a segment. Each segment is suitably provided with a cavity for each spring that actuates the segment. Thus, if several springs, such as two, three or four, actuate the segment, the segment comprises two, three or four cavities. Each cavity is adapted to receive an associated spring. An advantage of using cavities of this type is that they allow easy application of the springs.

The springs can advantageously be loosely arranged without being fixed in said cavities. When mounting the segments in the mounting of the lid or a seal holder associated therewith, a spring is simply let into the cavity, after which the segment is inserted into the mounting. To prevent the segment from springing out of the mounting before the lid is in the closing position against the pressure chamber, a stop arrangement is arranged according to the description above.

The springs can alternatively be fixed to the segments, so that one end of a spring is connected to a mounting forming portion, and the other end of the spring is connected to the segment. In this alternative, the springs also have the function of a stop arrangement. As stop element according to the previous description, for instance the fastening point, such as a hook, on the segment can be regarded as the actual stop element, whereby it is fixedly arranged relative to the segment but movably arranged relative to the mounting forming portion. The reverse is applicable if the fastening point on the mounting forming portion is regarded as the actual stop element.

The sealing means, or at least the major part of the sealing means, is preferably rigid, i.e. in contrast to a rubber seal which is relatively soft, the sealing means is relatively rigid and difficult to bend. An example of a material to be chosen for the segments included in the sealing means is metal, or a metal alloy such as bronze, for instance of the type JM1.

The seal according to the present invention can be used for both a vertical press and a horizontal press. In a vertical press, the pressure chamber is closed at least with an upper removable lid at the top of the pressure chamber and, optionally, a lower removable lid at the bottom of the pressure chamber. Since the function of the seal is, inter alia, to protect the environment from the hot gas used in pressurisation, which rises upwards, it is above all round the upper lid that the seal is to be applied. However, it will be appreciated that it is also possible to apply the seal round a lower lid, if any. In a horizontal press, when the lids in the respective ends of the pressure chamber have essentially the same position in the vertical direction, the seal is suitably applied round both lids.

According to another aspect of the invention, a method is provided for sealing a lid adapted to close a pressure chamber of an isostatic press. According to the method, a set of individual circular-arc-shaped segments is used as a seal. Each segment is placed in a mounting belonging to the lid, so that the segments together form a closed ring and seal between the lid and a pressure chamber wall when the lid closes the pressure chamber. Each segment is locked so that its mobility in the radial direction of extension of the lid is limited, and so that the segments are kept in the mounting also when the lid is removed from the pressure chamber.

It is to be noted that the mounting belonging to the lid can constitute either part of the actual lid or part of a detachable seal holder which is adapted to be mounted on the lid. In the case involving a seal holder, the segments can be placed in the mounting when the seal holder is already mounted on the lid, or alternatively before the seal holder is mounted on the lid. The segments are placed and locked in the mounting suitably independently of each other, such as one at a time.

According to yet another aspect of the invention, an isostatic press, preferably a hot isostatic press, is provided. The isostatic press comprises a pressure chamber and a lid for closing the pressure chamber, as described above. Moreover the isostatic press comprises a seal as stated above.

According to one more aspect of the invention, a lid is provided, which is adapted to close a pressure chamber of an isostatic press, which lid comprises a seal according to the above description.

According to another aspect of the invention, a seal holder is provided, which is adapted to be arranged, preferably detachably, on a lid for closing a pressure chamber of an isostatic press. The seal holder comprises a seal and a mounting according to the previous description.

According to a further aspect of the invention, use of a seal, according to the previous description, is provided for sealing a lid for a pressure chamber of an isostatic press.

### BRIEF DESCRIPTION OF THE DRAWINGS

FIG. 1 is an exploded view in perspective of an upper part of an isostatic press according to one embodiment of the invention.

FIG. 2 is a perspective view, in more detail, of a sealing means as used in the isostatic press according to FIG. 1.

FIG. 3 shows part of a seal holder in perspective and in cross-section, said seal holder being used in the isostatic press according to FIG. 1.

FIGS. 4a-e are cross-sectional views of alternative arrangements for limiting the radial movement of the sealing means according to the invention.

### DETAILED DESCRIPTION OF THE DRAWINGS

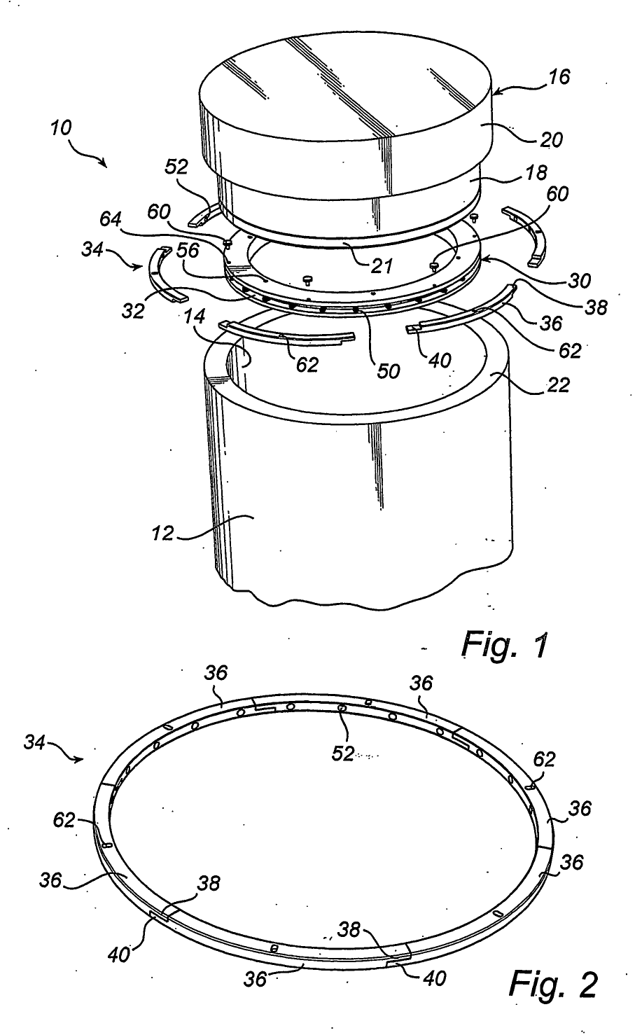

FIG. 1 is an exploded view in perspective of an upper part of an isostatic press 10 according to an embodiment of the invention. The isostatic press 10 comprises a pressure vessel 12 in the form of a cylinder, whose inner cylindrical wall surface 14 defines a pressure chamber, in which one or more articles that are to be subjected to pressure treatment are placed. The pressure chamber is filled with gas under high pressure and with a high temperature. The hot gas rises upwards in the pressure chamber, which in the pressure treatment is closed with a lid 16.

The lid 16 comprises an upper lid 18, 20 and a cooling lid (not shown). The upper lid is made in one piece and has the shape of two concentric and circular disc portions 18, 20. The upper lid is adapted to be inserted into the pressure chamber to close it, the lower disc portion 18 in the lowered position being essentially fully inserted into the pressure chamber while the upper disc portion 20 with the larger diameter is adapted to abut against the circular top surface 22 of the pressure chamber. A circumferential frame (not shown) is suitably arranged round the lid 16 and the pressure vessel 12 to keep them together and counteract opening forces that arise in the pressurisation of the pressure chamber. Under and adjacent to the lower part of the lower disc portion 18, the cooling lid (not shown) is mounted. A main seal 21 is arranged round the cooling lid.

A circular annular seal holder 30 is mountable on the cooling lid, or the main seal 21. The seal holder 30 has essentially the same outer diameter as the main seal 21 and as the lower disc portion 18 of the upper lid. The seal holder 30 has a circular groove 32 in its outer circumferential surface. A sealing means 34 (see FIG. 2) is applicable in the groove 32 to seal between the lid 16 (seal holder 30) and the wall 14 defining the pressure chamber. The sealing means 34 is applied by being moved radially inwards, as will be described below. The sealing means 34 has together with some other components in the inventive seal, among other things, the function of protecting the superposed main seal 21. A further function is to conduct heat to the wall 14 defining the pressure chamber.

The sealing means 34 comprises a set of curved segments 36, which together form a closed ring when they are applied in the groove 32 (see FIG. 1 and FIG. 2). In the shown embodiment, the sealing means 34 has six curved segments 36, but it will be appreciated that both a smaller number, such as 2-5, and a larger number, such as 7-12, or even more, are feasible as alternatives. Each segment 36 has an upper projecting portion 38 at one end and a lower projecting portion 40 at the other end. Each segment 36 is arranged so that its upper projecting portion 38 overlaps, in the applied state, the lower projecting portion 40 of an adjoining segment. In FIGS. 1 and 2, thus all segments 36, seen in the clockwise direction, have their lower projecting portion 40 at the very front and their upper projecting portion 38 at the very back. The overlap minimises the possibility of the hot rising gas leaking past the seal which is provided by means of the segments 36.

A plurality of springs 50 are arranged between the sealing means 34, i.e. the segments 36, and the seal holder 30. The springs 50 extend in the radial direction in the groove 32 into a cavity 52 each in the sealing means 34. FIG. 1 and FIG. 2 show that each segment 36 has four cavities 52, and thus each segment 36 should be actuated by four springs 50. The springs 50 are suitably placed in the cavities of the segments 36, before the segments 36 are applied in the groove 32. The outwardly directed radial force from the springs 50 causes the segments 36, in the closing position of the lid 16, to be pressed against the wall 14 defining the pressure chamber, thereby achieving a good sealing effect.

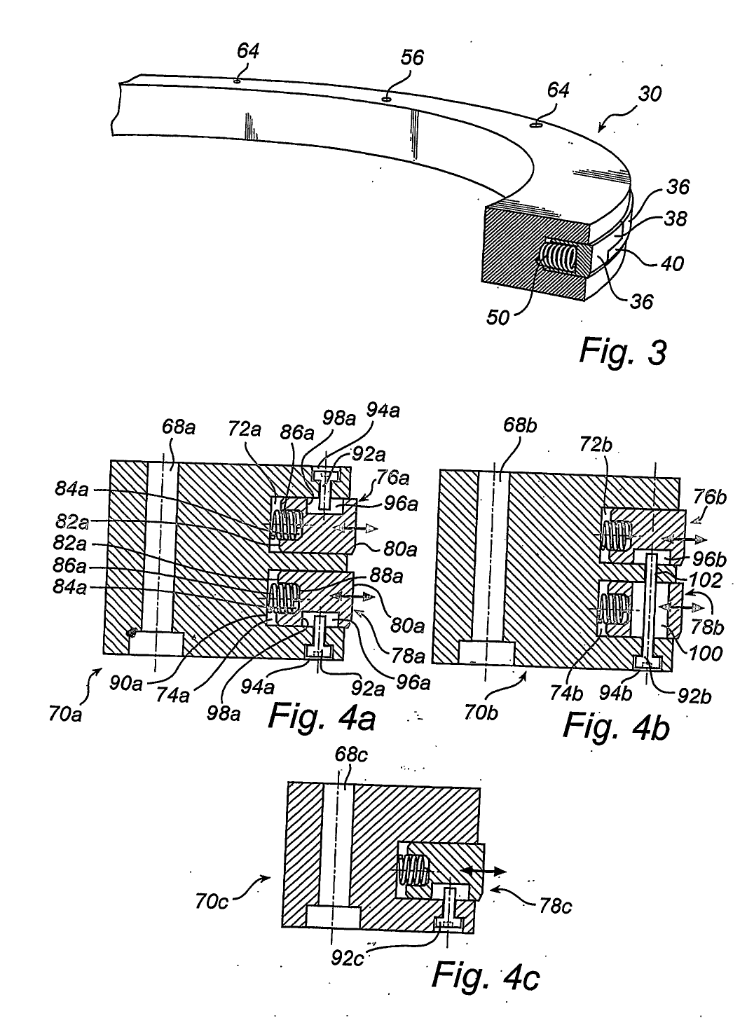

FIG. 3 shows in more detail part of the seal holder 30 in perspective and in cross-section. Especially FIG. 3 shows the segments 36 mounted in the seal holder 30 and the location of a spring 50 between the seal holder 30 and a segment 36. Moreover the seal holder 30 is shown to have mounting holes 56 to fasten the seal holder 30 to the cooling lid (see also FIG. 1) by means of a fastener, such as a screw.

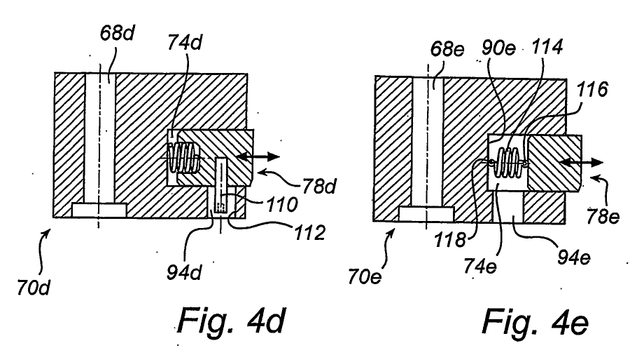

When the lid 16 is to be removed from the pressure chamber and the wall 14 defining the pressure chamber does not any longer constitute a stop against the radial expansion of the sealing means 34, the pressing effect of the springs is counteracted by means of a set of stop elements 60 (see FIG. 1). The function of the stop elements 60 is used also when the lid 16 is to be lowered to close the pressure chamber, so that the springs 50 do not make the segments 36 fall out of the groove 32 of the seal holder 30. As is evident from FIG. 1 and FIG. 2, each segment 36 is provided with a recess 62. As is also evident from FIG. 1 and FIG. 3, the seal holder 30 has spaced-apart through holes 64 which are to be vertically aligned with an associated recess 62 when the segments 36 are placed in the groove 32. Each stop element 60 is placed in its hole 64 in the seal holder 30 so that it also extends into the recess 62 of the segment 36 and, thus, locks the segment 36 to the seal holder 30 at least partially. Some mobility is allowed as will be explained in connection with the following description of FIGS. 4a-4e. As is evident from the previous description, each segment 36 can be applied and locked in the groove 32 of the seal holder 30 independently of the other segments 36.

FIGS. 4a-4e show in cross-section alternative arrangements for limiting the radial movement of the sealing means according to the invention. The Figures are cross-sections of different types of seal holder with segments arranged therein and an associated stop arrangement. In the different FIGS. 4a-4e, components which are described in one of the Figures and which have equivalents in one of the other Figures, are given the same reference numerals with the corresponding letter a-e added. A common feature of these four alternatives is, inter alia, that each seal holder 70a-70e has an associated through mounting hole 68a-68e in which fasteners are inserted for fastening the seal holder to the lid.

FIG. 4a shows that two sealing means can be used in order to further increase safety and sealing capability. Thus, the shown seal holder 70a has two circumferential grooves 72a, 74a for receiving two sets of circle-forming segments 76a, 78a. Each segment 76a, 78a has a radial outside 80a adapted to seal against a wall defining the pressure chamber and a radial inside 82a. When the segments 76a, 78a are arranged in the grooves 72a and 74a respectively and thus form two annular sealing means, the radial outside 80a thus determines the outer diameter of the sealing means while the radial inside 82a determines the inner diameter of the sealing means. The radial inside 82a of the segments 76a, 78a is provided with radially extended cavities 84a in which springs 86a are placed with no special fastening. When the segments 76a, 78a are inserted into the grooves 72a and 74a respectively of the seal holder 70a, each spring 86a thus extends between the vertical end face 88a of a cavity 84a and a vertical groove-defining surface 90a of the seal holder 70a. The springs 86a will exert a force on the segments 76a, 78a radially outwards, so that the radial outside 80a of the segments will abut against the wall defining the pressure chamber also when this wall expands in the course of a pressure treatment.

FIG. 4a also shows that the possibility of the segments 76a, 78a moving radially is limited by a stop arrangement. The stop arrangement comprises locking screws 92a which are inserted into and fastened in through holes 94a in the seal holder 70a and which extend into recesses 96a of the segments 76a, 78a. The size of the recesses 96a in the radial direction of extension of the circular sealing means is greater than the portion of the locking screw 92a which extends into the associated recess 96a. This difference in size allows a limited radial movement (illustrated by double arrows). If the segments 76a, 78a are not surrounded by the pressure vessel, the outwards resilience of the sealing means is stopped when the radially seen inner end faces 98a of the recesses 96a come into contact with the respective locking screws 92a.

The segments, or at least the segment 76a of the upper sealing means, are placed and locked in the grooves preferably before the seal holder 70a is mounted on the lid, since the upper locking screws are easier to reach than in the mounted position of the seal holder. An alternative would be to adjust the design of the lid to make it possible to insert the locking screw through the through hole of the seal holder also when the seal holder is already mounted on the lid.

An alternative to the stop arrangement shown in FIG. 4a for two annular sealing means is shown in FIG. 4b. In this case, a single vertically extended cavity is formed for each locking screw 92b. Seen from below the cavity is in turn formed by
a through hole 94b extending from the bottom of the seal holder to the lower groove 74b;
a through hole 100 in a segment 78b in the lower sealing means;
a through hole 102 in the central portion of the seal holder 70b, which hole 102 extends from the lower groove 74b to the upper groove 72b; and
a recess 96b formed in the lower portion of a segment 76b in the upper sealing means.

Thus use is made of a common locking screw 92b for limiting the radial movement of both an upper segment 76b and a lower segment 78b. An advantage of this embodiment is that the seal holder can be fixed to the lid in mounting and/or dismounting of the sealing means, since the locking screw 76b can be reached from below without being obstructed by the design of the superposed lid.

FIG. 4c illustrates that, instead of two sealing means, it may in some cases be enough to have one sealing means in a seal holder 70c. This stop arrangement with the locking screw 92c which cooperates with a segment 78c thus corresponds to that shown for the locking screw 92a and the segment 78a in the lower sealing means in FIG. 4a.

FIG. 4d illustrates an embodiment in which a locking screw 110 is fixed in a segment 78d instead of in the seal holder 70d, and that the through hole 94d of the seal holder in the radial direction of extension is over-dimensioned relative to the diameter of the locking screw 110. Thus, the outer end face 112, seen in the radial direction, of the hole 94d comes into contact with the locking screw 110 and thus prevents the segment 78d from falling out of the groove 74d when the lid is not placed in the pressure vessel. The locking screw 110 is easy to reach and can be screwed into and out of the segment 78d through the hole 94d in the seal holder 70d.

FIG. 4e shows another embodiment, in which the radial movement is limited by the same spring 114 that performs the radial pressing operation. The spring 114 can be reached through a through hole 94e in the seal holder and can be fixed by fastening means 116, 118, such as hooks and eyelets, with one end to the segment 78e and with the other end to the groove-defining wall 90e of the holder 70e. Thus, the spring 114 keeps the segments 78e in the groove 74e also when the lid is not in its closing position on the pressure chamber.

It should be observed that even if all Figures have been illustrated with a seal holder, the arrangements in FIGS. 4b-4e could, for instance, be applied directly to a lid without a seal holder, thus eliminating one component. In such a case, the lid is provided with the necessary groove and through holes.

1. A seal comprising a sealing arrangement which is applicable in a mounting and intended for a lid of an isostatic press, said lid having a first position in which the lid closes a pressure chamber of the isostatic press and a second position in which the lid is separated from the pressure chamber, the sealing arrangement being applicable in the mounting so that, in said first position, the sealing arrangement seals between the lid and a pressure chamber wall;
the sealing arrangement comprising at least two individual circular-arc-shaped segments which together form a closed ring when they are placed in the mounting; and
wherein a stop arrangement is arranged to limit movements of the segments so that these segments are kept in the mounting also in said second position.

2. The seal as claimed in claim 1, wherein at least one part of said stop arrangement is detachably arranged on the segments.

3. The seal as claimed in claim 1, wherein said stop arrangement comprises a set of stop elements the movement of each segment being limited by at least one stop element, each stop element limiting only the movement of one segment.

4. The seal as claimed in claim 3 wherein each stop element is arrangeable so as to extend between a mounting forming portion and a segment, and so as to be movably arranged relative to the segment, but fixedly arranged relative to the mounting forming portion or vice versa.

5. The seal as claimed in claim 4 wherein the stop element is fixedly arrangeable in said mounting forming portion and has a stop portion extending into a recess in the segment, the extent of the recess in the radial direction of extension of the sealing arrangement being greater than the extent of the stop portion in said direction.

6. The seal as claimed in claim 1, which further comprises a spring assembly which is arranged to actuate the segments, each segment, when placed in the mounting, being subjected to a force directed outwards in the radial direction of extension of the sealing arrangement.

7. The seal as claimed in claim 6 wherein said spring assembly comprises a set of individual springs each segment being actuated by at least one spring, each spring actuating one segment only.

8. The seal as claimed in claim 7 wherein each segment comprises a plurality of cavities each cavity being adapted to receive a spring which is adapted to extend, in the radial direction of extension of the sealing arrangement, from a mounting forming portion into the cavity.

9. The seal as claimed in 8 wherein each spring is loosely arranged without being fixed in said cavity.

10. The seal as claimed in claim 1, wherein each segment has, at both ends, a projecting portion which, with the segments placed in the mounting, overlaps a corresponding projecting portion of an adjoining segment.

11. The seal as claimed in claim 1, wherein said mounting comprises a circular groove in a seal holder belonging to the lid.

12. A method for sealing a lid adapted to close a pressure chamber of an isostatic press comprising.
using as a seal a set of individual circular-arc-shaped segments;
placing each segment in a mounting belonging to the lid, so that the segments together form a closed ring and seal between the lid and a pressure chamber wall when the lid closes the pressure chamber; and
locking each segment so that its mobility in the radial direction of extension of the lid is limited, and so that the segments are kept in the mounting also when the lid is removed from the pressure chamber.

13. The method as claimed in claim 12, which further comprises actuating each segment by a spring force directed outwards in the radial direction of extension of the lid, so that the radial position of the segments is adjusted to the expansion of the pressure chamber during a press operation.

14. The method as claimed in claim 12, in which the seal is established by placing and locking one segment at a time.

15. An isostatic press, comprising:
a pressure chamber:
a lid for closing the pressure chamber, said lid having a first position in which it closes the pressure chamber and a second position in which it is separated from the pressure chamber:
a mounting for receiving a sealing arrangement;
a sealing arrangement which is applicable in said mounting and intended for said lid, the sealing arrangement being arranged to, in said first position of the lid, seal between the lid and a pressure chamber wall, the sealing arrangement comprising at least two individual circular-arc-shaped segments which together form a closed ring when they are placed in the mounting: and
a stop arrangement arranged to limit movements of the segments so that the segments are kept in the mounting also in said second position.

16.-18. (canceled)
